(19) United States
(12) Patent Application Publication
(10) Pub. No.: US 2009/0014472 A1
(43) Pub. Date: Jan. 15, 2009

(54) Hot lather dispenser

(76) Inventor: Calvin Ree Farmer, Memphis, TN (US)

Correspondence Address: Charles F. Rye, Patent Attorney, Fifth Floor, 8 South Third Street, Memphis, TN, 38103, US

(21) Appl. No.: 12/156,742

(22) Filed: Jun. 4, 2008

Related U.S. Application Data
(60) Provisional application No. 60/937,083, filed on Jun. 4, 2007.

(51) Int. Cl. B67D 5/62

(52) U.S. Cl. 222/146.2

(57) ABSTRACT

A device for holding containers and warming their contents. The containers are removably attached to the cover of the device by a neck which accommodates a dispenser pump. The containers hold substances such as creams, pastes, gels, lotions and the like especially, shaving cream liquid solution. The temperature of the device can be preset or adjustable. Timers can select the time of day to begin and end the heat cycle. Visual and/or audio indicators can be activated to indicate the substances are at the desired temperature. The device cover may include a scupper ledge contain any spillage from the dispenser pump.

### SUMMARY OF THE INVENTION

Heated dispensers for personal care fluids and creams and especially shaving lather are old in the art. An electrically heated shaving mug was patented by at least 1919. Providing heat for shaving lather has followed the progression of advances in convenience to the user through the years including providing heat to aerosol can shaving creams either directly to the can or to the lather as it is used. Professionals certainly prefer heated lather as it is soothing to the client, better prepares the hair and skin for shaving and it is just plain expected.

Some hot lather dispensers that are currently utilized have draw backs of requiring mixing of the shaving cream base and water, open reservoir and require careful placement in the work area because of their shape and location of the dispenser nozzle. There are also problematic with leaks and spills that tend to attract pests. The current invention provides a stable receptacle with thermostatically controlled heat. The shaving cream fluid containers are suspended by their necks through the cover. The necks of the containers accommodate dispenser pumps that create shaving cream foam from a liquid during the pumping action. If variations of shaving cream are desired including, but not limited to, fragrance the containers will be shaped to nest together and still provide for efficient use of the interior volume of the heated receptacle with its cover in place. This also accommodates heated fluids, creams and gels other than shaving cream. The necks on the containers will be positioned such that the fluid weight tends to pull on the neck and suspend the container in a substantially vertical position in order that they nest properly which promotes easy installation and removal of the container group suspended from the cover and maintains the a gap between the containers and the heated wall or base of the receptacle. The vertical pull on the neck also keeps the container in a proper position for use even if the user decides to operate the dispenser with less than to total number of containers it may hold. Also included is a plug(s) to close unused apertures. The cover will have apertures concomitant with the neck position of the containers as nested together from one aperture in the center for a single container to a uniform ring of apertures which accommodate a group of containers which resemble a sliced pie when viewed from the top. Other variations of the containers may include a major volume container with a minor volume container nested in a vertical pocket in the upper surface of the major volume container and a complementary aperture pattern in the cover. A variation of the cover is also provided for that has an outer scupper ledge to catch any drips from the dispenser pumps or outlets. Bulk fluids may be sold with a new pump which is clearly marked to identify the products in each container loaded in the receptacle.

Add on digital devices are well know to be incorporated on a multitude of useful item. As with many others, this invention can be modified with electronics for the convenience of the user. Professionals and even consumers would want to have the product heated and ready to go by the time of its first expected daily use and also automatically shut down and also provide programmable weekly schedules. This is easily accomplished by off the shelf controllers. Another useful feature would be one or more programmable start/stop timers that give a signal to end any timed activities. The controller may also be adaptive for any data communication for information or control of itself or other devices by way of hard wire interconnects or remote communication systems. The current invention includes a controller which may be timed, multifunction timers and a communication port(s).

### DESCRIPTION OF THE DRAWINGS

FIG. 1. shows the receptacle, container, lid and dispenser pump.

FIG. 2. shows pie shaped containers.

FIG. 3. shows nested major and minor containers and lid.

FIG. 4. Shows a cover having apertures and turning indentations.

FIG. 5. shows a cover with a scupper lip.

### DETAILED DESCRIPTION OF THE DRAWINGS

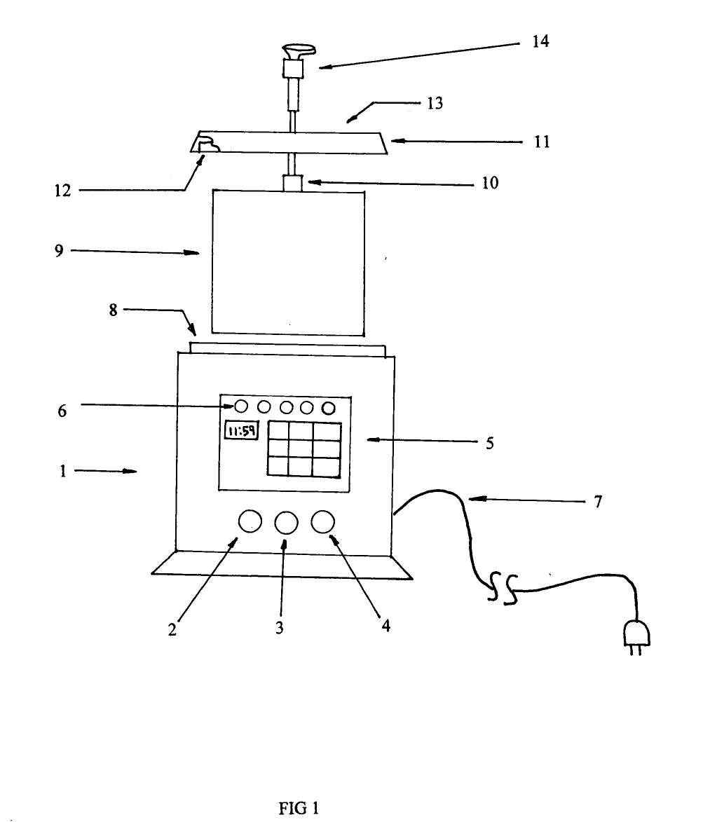

FIG. 1. Shows front views of heated receptacle 1 with power indicator light 2, thermostat 3, temperature light 4, controller 5, start/stop timers 6, power plug 7 and bearing sure 8. Container 9 is shown with neck 10. Cover 11 is shown with bearing surface 12 and aperture 13. Neck 10 is passed through aperture 13 and dispenser pump 14 is threaded to neck 10 and container 9 attached to cover 11 which is lowered into receptacle 1 contacting bearing surfaces 8 and 12.

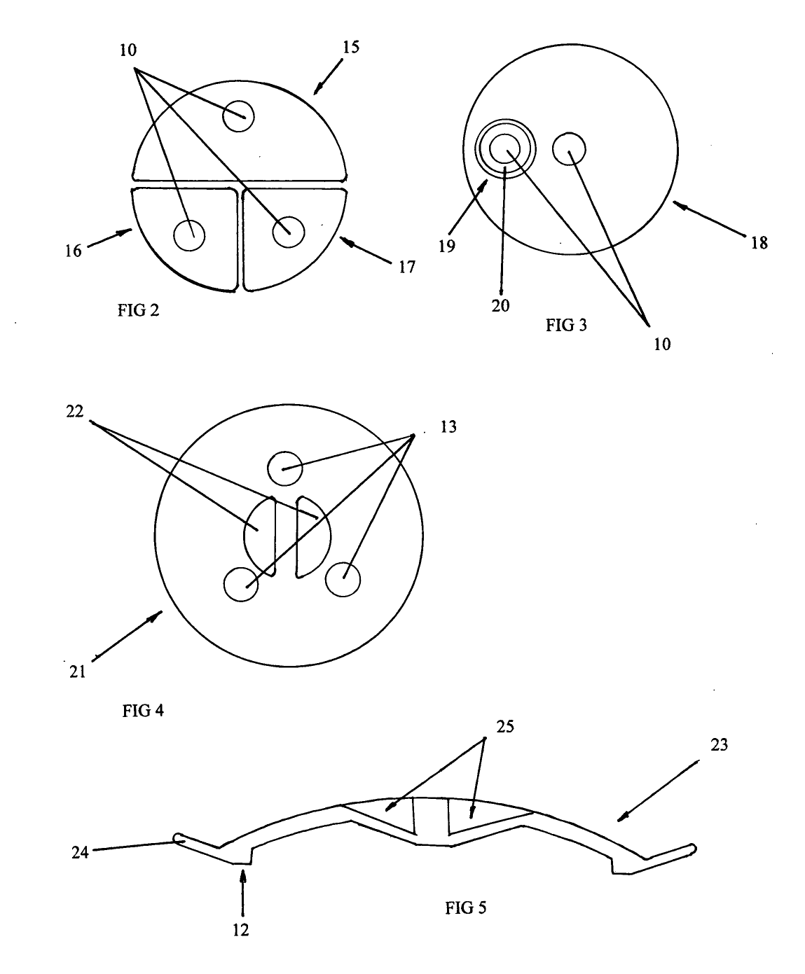

FIG. 2. Shows top views of major volume container 15 with neck 10 and is ½ pie shaped through its horizontal cross section. Minor volume containers 16 and 17 with necks 10 are ¼ pie shaped through their horizontal cross sections and nest with container 15 to approximate the shape and volume of a single container.

FIG. 3. Shows top views of major volume container 18 with neck 10 having a vertical pocket 19. Minor volume container 20 with neck 10 is nested inside vertical pocket 19.

FIG. 4. Shows a top view of cover 21 having apertures 13 and turning indentations 22.

FIG. 5. Shows a cross section of cover 23 having scupper ledge 24 around its perimeter, turning indentations 25 and bearing surface 12. Bearing surfaces 8 (FIG. 1) and bearing sure 12 slideably accommodate rotation of the lid to different pumps.

The specification and drawings of this application are intended to illuminate the invention and preferred embodiment without limitation upon the claims.

I claim:

1. A warmer device, comprising;
a receptacle having substantially uniform cylindrical sidewall;
a cover defining at least one aperture;
a controllable heat source;
at least one fluid container(s) defining at least one chamber having at least one neck per chamber on its upper region adaptable to pass through said cover aperture(s) and removable suspended by said cover, and
a dispenser pump adaptable to each said container neck.

2. The device of claim 1 further comprising;
said receptacle having an insulated exterior;
said cover having an insulated exterior;
said heat source power being electricity; and
said fluid container(s) being substantially the volume of said receptacle interior with said cover fitted but not in contact with said receptacle.

3. The device of claim 1 further comprising:
at least two fluid containers each defining at least one chamber having a substantially pie shape horizontal cross section and when nested together being substantially the volume of said receptacle interior with said cover fitted but not in contact with said receptacle;
said containers having at least one neck per chamber on its upper region positioned so that fluid weight in the container creates a substantially vertical pull on said neck(s);
a cover defining apertures of at least a number equal to the number of said container necks; and
at least one plug adaptive to fill any unused cover apertures.

4. The device of claim 1 further comprising:
at least two containers each defining at least one chamber having at least one neck per chamber on its upper region;
one said container constituting a major volume and further defining at least one vertical pocket extending downward from its upper region;
at least one secondary container constituting a minor volume whose outer shape slideably fits into said pocket(s) of said major volume container;
said containers having at least one neck per chamber on its upper region positioned so that fluid weight in the container creates a substantially vertical pull on said neck(s);
a cover defining apertures at least a number equal to the number of said container necks and positioned concomitant with the neck(s) of the major and minor containers; and
at least one plug adaptive to fill any unused cover apertures.

5. The device of claim 1 further comprising:
said receptacle's upper region defining a lip comprising a horizontal bearing surface; and
said cover's outer perimeter rotatably slideably concomitant with said bearing surface and said cover further defining depressions in its upper surface convenient for human grasp to rotate said cover.

6. The device of claim 1 further comprising:
said receptacle's upper region defining a lip comprising a bearing ledge;
a bearing adaptive to removeably fit on said bearing ledge; and
said cover's outer perimeter slideably concomitant with said bearing and said cover further defining turning indentations in its upper surface convenient for human grasp to rotate said cover.

7. A warmer device, comprising;
a receptacle having substantially uniform cylindrical sidewall, an insulated outer surface, a thermostatic regulated electric heat source mounted within said outer surface, power and temperature indicators and an upper lip defining a horizontal bearing surface;
an insulated cover defining at least one aperture and its outer perimeter slideably concomitant with said bearing surface and said cover further defining tuning indentations in its upper surface convenient for human grasp to rotate said cover;
at least one plug adaptive to fill any unused cover apertures;
at least one fluid container(s) defining at least one chamber having at least one neck per chamber on its upper region adaptable to pass through said cover aperture(s) and removable suspended by said cover; and
a dispenser pump adaptable to said container neck(s).

8. The device of claim 7 comprising;
said thermostat fixed at 110 degrees Fahrenheit.

9. The device of claim 7 comprising:
said thermostat is adjustable above 110 degrees Fahrenheit.

10. The device of claim 7 comprising:
said cover having a circumferential upward sweeping scupper ledge extending beyond said outer perimeter.

11. The device of claim 7 further comprising:
said receptacle's upper region defining a lip comprising a bearing ledge;
a bearing adaptive to removeably fit on said bearing ledge; and
said cover's outer perimeter slideably concomitant with said bearing.

12. The device of claim 7 further comprising:
at least two fluid containers each defining at least one chamber having a substantially pie shape horizontal cross section when nested together substantially filling the volume of said receptacle interior with said cover fitted, but not in contact with said receptacle;
said containers having at least one neck per chamber on its upper region positioned so that fluid weight in the container tends to create a vertical pull on said neck(s);
a cover defining apertures of at least a number equal to the number of containers required to substantially fill said receptacle; and
at least one plug adaptive to fill any unused cover apertures.

13. The device of claim 7 further comprising:
at least two containers each defining at least one chamber having a neck per chamber on its upper region;
one said container constituting a major volume and further defining at least one vertical pocket extending downward from its upper region;
at least a second container constituting a minor volume whose outer shape slideably fits into said pocket(s) of said major volume container;
said containers having at least one neck per chamber on its upper region positioned so that fluid weight in the container tends to create a vertical pull on said neck(s);
a cover defining apertures at least positioned concomitant with the neck(s) of the major and minor containers; and
at least one plug adaptive to fill any unused cover apertures.
